(19) United States
(12) Patent Application Publication
(10) Pub. No.: US 2006/0138773 A1
(43) Pub. Date: Jun. 29, 2006

(54) Adapter having efficiently positioning effect

(76) Inventors: Chung-Chen Feng, Sinjhuang City (TW); Ching-Wen Chen, Taipei City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/247,909

(22) Filed: Oct. 11, 2005

(30) Foreign Application Priority Data
Dec. 24, 2004 (TW) 093220887

(51) Int. Cl. F16L 13/00

(52) U.S. Cl. 285/285.1

(57) ABSTRACT

An adapter includes a metallic connector having an end portion formed with a mounting recess having a bottom formed with an annular flange having a top side formed with a receiving space, a metallic connecting pipe having an end portion inserted into the mounting recess of the metallic connector and stopped by the annular flange of the mounting recess, and a fusible metal paste coated between the mounting recess of the metallic connector and the end portion of the metallic connecting pipe. Thus, the metallic connector and the metallic connecting pipe are combined together rigidly and stably by the fusible metal paste, so that the adapter has a reinforced strength and solidified structure.

### BACKGROUND OF THE INVENTION

1. Field of the Invention

The present invention relates to an adapter, and more particularly to an adapter having an efficiently positioning effect.

2. Description of the Related Art

A conventional adapter in accordance with the prior art shown in FIGS. 8 and 9 comprises a metallic connector 4 having an end portion formed with a mounting recess 41 having a bottom formed with an annular flange 42, a metallic connecting pipe 20 having an end portion inserted into the mounting recess 41 of the metallic connector 4 and stopped by the annular flange 42 of the mounting recess 41, and an adhesive 5 coated around the end portion of the metallic connecting pipe 20 and adhered to the mounting recess 41 of the metallic connector 4 to secure the end portion of the metallic connecting pipe 20 to the metallic connector 4. The metallic connecting pipe 20 has an outer thread 201 screwed into the mounting recess 41 of the metallic connector 4.

However, the adhesive 5 is easily loosened during a long-term utilization, so that the metallic connecting pipe 20 and the metallic connector 4 are not combined rigidly and stably by the adhesive 5. In addition, the adhesive 5 is made of insulating material, so that the adhesive 5 easily decrease the electric connection between the metallic connecting pipe 20 and the metallic connector 4, thereby greatly increasing the grounding resistance and noise interruption of the adapter.

### SUMMARY OF THE INVENTION

In accordance with the present invention, there is provided an adapter, comprising a metallic connector having an end portion formed with a mounting recess having a bottom formed with an annular flange having a top side formed with a receiving space, a metallic connecting pipe having an end portion inserted into the mounting recess of the metallic connector and stopped by the annular flange of the mounting recess, and a fusible metal paste coated between the mounting recess of the metallic connector and the end portion of the metallic connecting pipe.

The primary objective of the present invention is to provide an adapter having an efficiently positioning effect.

Another objective of the present invention is to provide an adapter, wherein the metallic connector and the metallic connecting pipe are combined together rigidly and stably by the fusible metal paste, so that the adapter has a reinforced strength and solidified structure.

A further objective of the present invention is to provide an adapter, wherein the fusible metal paste has an excellent electric conducting feature, so that the metallic connector and the metallic connecting pipe are electrically connected smoothly, thereby greatly enhancing the electric conductivity of the adapter, and thereby reducing the grounding resistance and noise interruption of the adapter.

A further objective of the present invention is to provide an adapter, wherein the metallic connector and the metallic connecting pipe are combined easily and rapidly, so that the adapter is worked easily and conveniently.

Further benefits and advantages of the present invention will become apparent after a careful reading of the detailed description with appropriate reference to the accompanying drawings.

### BRIEF DESCRIPTION OF THE DRAWINGS

FIG. 1 is a partially cut-away perspective view of an adapter in accordance with the preferred embodiment of the present invention.

FIG. 2 is an exploded perspective cross-sectional view of the adapter as shown in FIG. 1.

FIG. 3 is a plan cross-sectional view of the adapter as shown in FIG. 1.

FIG. 4 is an exploded perspective cross-sectional view of an adapter in accordance with another preferred embodiment of the present invention.

FIG. 5 is a plan cross-sectional assembly view of the adapter as shown in FIG. 4.

FIG. 6 is an exploded perspective cross-sectional view of an adapter in accordance with another preferred embodiment of the present invention.

FIG. 7 is a plan cross-sectional assembly view of the adapter as shown in FIG. 6.

FIG. 8 is a partially cut-away perspective view of a conventional adapter in accordance with the prior art.

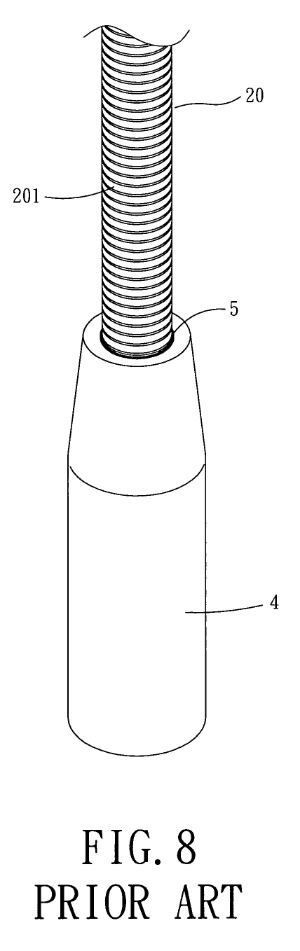

FIG. 9 is a plan cross-sectional view of the conventional adapter as shown in FIG. 8.

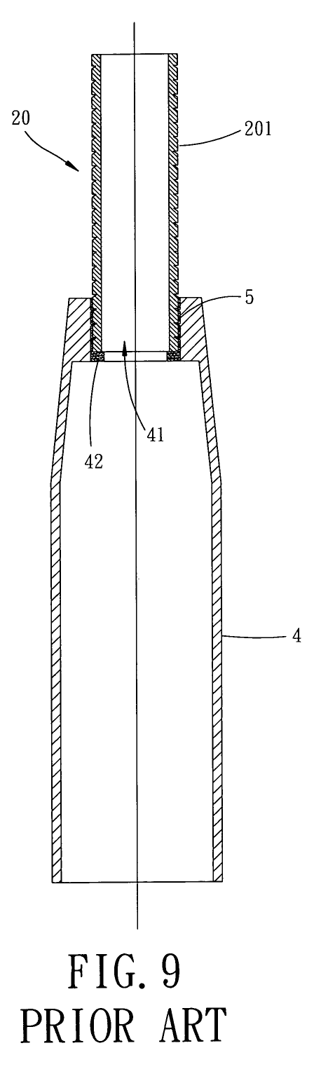

### DETAILED DESCRIPTION OF THE INVENTION

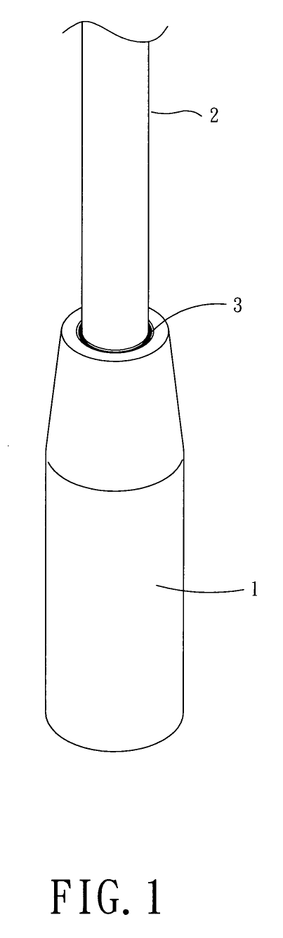

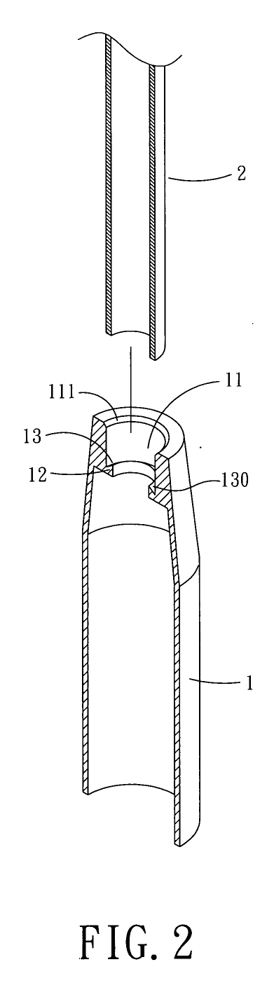

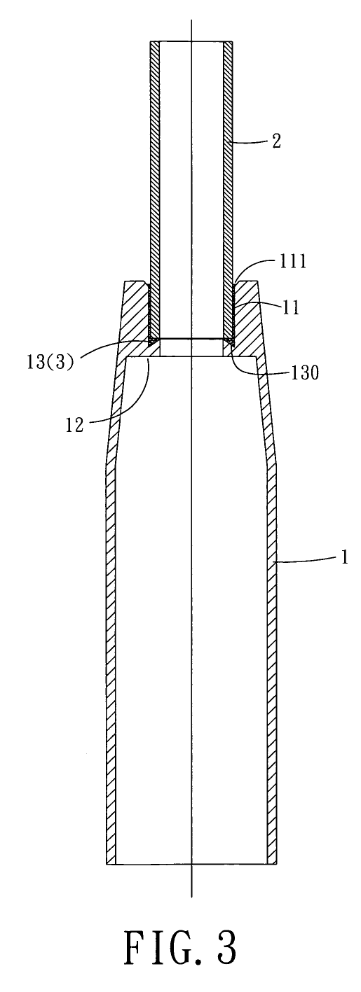

Referring to the drawings and initially to FIGS. 1-3, an adapter in accordance with the preferred embodiment of the present invention comprises a metallic connector 1 having an end portion formed with a mounting recess 11 having a bottom formed with an annular flange 12 having a top side formed with a receiving space 13, a metallic connecting pipe 2 having an end portion inserted into the mounting recess 11 of the metallic connector 1 and stopped by the annular flange 12 of the mounting recess 11, and a fusible metal paste 3 coated between the mounting recess 11 of the metallic connector 1 and the end portion of the metallic connecting pipe 2 and partially received in the receiving space 13 of the annular flange 12.

The metallic connector 1 is a housing of an article to be connected, such as a microphone or the like. The mounting recess 11 of the metallic connector 1 has an opening having a periphery formed with a tapered (or stepped) edge 111. The receiving space 13 of the annular flange 12 of the metallic connector 1 is connected to the mounting recess 11 and located between the annular flange 12 of the metallic connector 1 and the end portion of the metallic connecting pipe 2. The receiving space 13 of the annular flange 12 of the metallic connector 1 is a tapered groove and has an oblique side 130 directed radially and outwardly from the metallic connector 1 to stop the fusible metal paste 3.

The metallic connecting pipe 2 is a bendable hose.

The fusible metal paste 3 contains metallic powder or metallic granules. The fusible metal paste 3 is initially coated around a periphery of the end portion of the metallic connecting pipe 2 or a periphery of the mounting recess 11 of the metallic connector 1.

When the fusible metal paste 3 is melted by heating, the melted fusible metal paste 3 is extended between the periphery and bottom of the mounting recess 11 of the metallic connector 1 and the periphery of the end portion of the metallic connecting pipe 2, and a substantially L-shaped contact face is formed between the metallic connector 1 and the metallic connecting pipe 2 after the melted fusible metal paste 3 is solidified, so that the metallic connector 1 and the metallic connecting pipe 2 are combined together rigidly and stably. The residual melted fusible metal paste 3 is compressed outwardly from the tapered edge 111 of the mounting recess 11 of the metallic connector 1. The melted fusible metal paste 3 is deposited and stored in the receiving space 13 of the annular flange 12 of the metallic connector 1 to prevent the melted fusible metal paste 3 from entering the metallic connector 1 and the metallic connecting pipe 2, thereby preventing the wires passing through the metallic connector 1 and the metallic connecting pipe 2 from being choked.

Accordingly, the metallic connector 1 and the metallic connecting pipe 2 are combined together rigidly and stably by the fusible metal paste 3, so that the adapter has a reinforced strength and solidified structure. In addition, the fusible metal paste 3 has an excellent electric conducting feature, so that the metallic connector 1 and the metallic connecting pipe 2 are electrically connected smoothly, thereby greatly enhancing the electric conductivity of the adapter, and thereby reducing the grounding resistance and noise interruption of the adapter. Further, the metallic connector 1 and the metallic connecting pipe 2 are combined together easily and rapidly, so that the adapter is worked easily and conveniently.

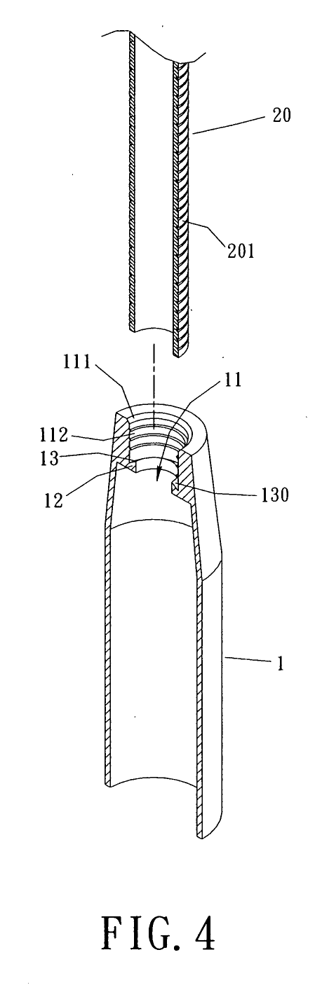

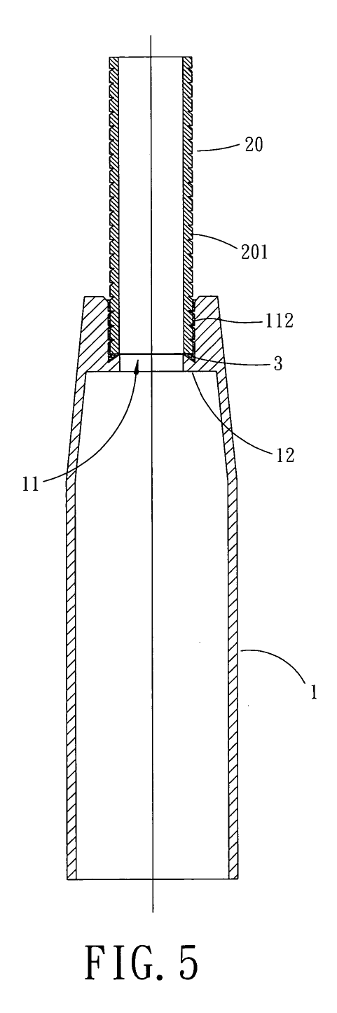

Referring to FIGS. 4 and 5, the mounting recess 11 of the metallic connector 1 has a periphery formed with an inner thread 112, and the metallic connecting pipe 2 has a corrugated shape and has a periphery formed with an outer thread 201 screwed into the inner thread 112 of the metallic connector 1, so that the metallic connector 1 and the metallic connecting pipe 2 are combined together rigidly and stably.

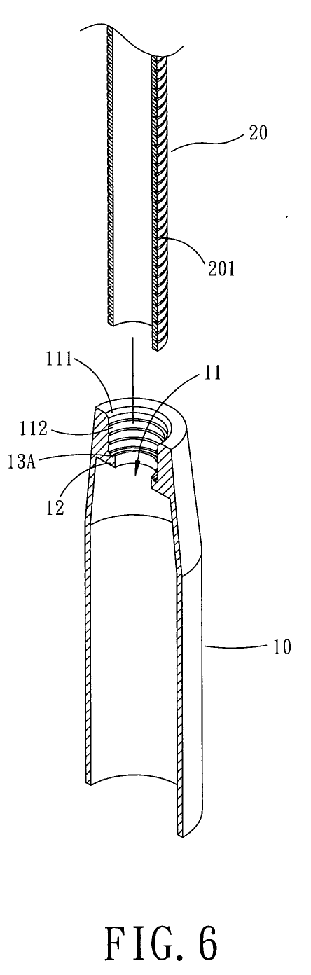

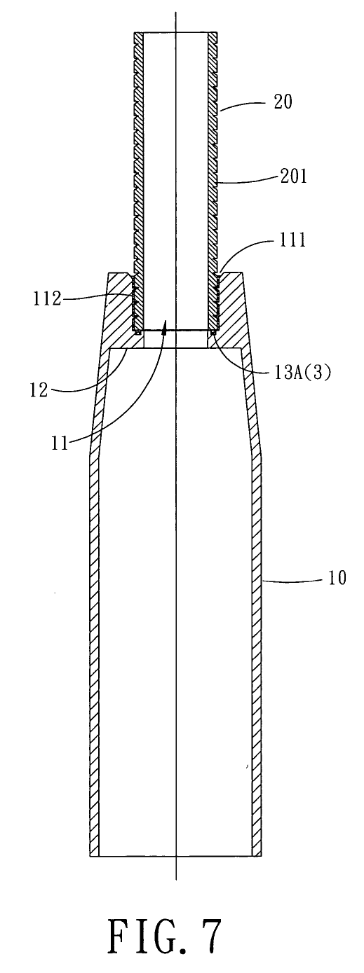

Referring to FIGS. 6 and 7 the receiving space 13 of the annular flange 12 of the metallic connector 1 is an annular groove.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. An adapter, comprising:
a metallic connector having an end portion formed with a mounting recess having a bottom formed with an annular flange having a top side formed with a receiving space;
a metallic connecting pipe having an end portion inserted into the mounting recess of the metallic connector and stopped by the annular flange of the mounting recess;
a fusible metal paste coated between the mounting recess of the metallic connector and the end portion of the metallic connecting pipe.

2. The adapter in accordance with claim 1, wherein the fusible metal paste is partially received in the receiving space of the annular flange.

3. The adapter in accordance with claim 1, wherein the mounting recess of the metallic connector has an opening having a periphery formed with a tapered edge.

4. The adapter in accordance with claim 1, wherein the receiving space of the annular flange of the metallic connector is connected to the mounting recess.

5. The adapter in accordance with claim 1, wherein the receiving space of the annular flange of the metallic connector is located between the annular flange of the metallic connector and the end portion of the metallic connecting pipe.

6. The adapter in accordance with claim 1, wherein the receiving space of the annular flange of the metallic connector is a tapered groove.

7. The adapter in accordance with claim 1, wherein the receiving space of the annular flange of the metallic connector has an oblique side directed radially and outwardly from the metallic connector to stop the fusible metal paste.

8. The adapter in accordance with claim 1, wherein the metallic connecting pipe is a bendable hose.

9. The adapter in accordance with claim 1, wherein the fusible metal paste contains metallic powder or metallic granules.

10. The adapter in accordance with claim 1, wherein the mounting recess of the metallic connector has a periphery formed with an inner thread, and the metallic connecting pipe has a corrugated shape and has a periphery formed with an outer thread screwed into the inner thread of the metallic connector.

11. The adapter in accordance with claim 1, wherein the receiving space of the annular flange of the metallic connector is an annular groove.

12. The adapter in accordance with claim 1, wherein the fusible metal paste is initially coated around a periphery of the end portion of the metallic connecting pipe.

13. The adapter in accordance with claim 1, wherein the fusible metal paste is initially coated around a periphery of the mounting recess of the metallic connector.

14. The adapter in accordance with claim 1, wherein when the fusible metal paste is melted by heating, the melted fusible metal paste is extended between a periphery and the bottom of the mounting recess of the metallic connector and a periphery of the end portion of the metallic connecting pipe, and a substantially L-shaped contact face is formed between the metallic connector and the metallic connecting pipe after the melted fusible metal paste is solidified.

15. The adapter in accordance with claim 1, wherein the melted fusible metal paste is deposited and stored in the receiving space of the annular flange of the metallic connector to prevent the melted fusible metal paste from entering the metallic connector and the metallic connecting pipe.
